(19) United States
(12) Patent Application Publication
(10) Pub. No.: US 2002/0043249 A1
(43) Pub. Date: Apr. 18, 2002

(54) Fuel rail with intergal dampening features

(76) Inventors: Ki-Ho Lee, Windsor (CA); Chris Heacock, Windsor (CA); Jeffery E. Brittle, Williamsburg, VA (US); James R. Morris, Newport News, VA (US); Ross Wood, Yorktown, VA (US); Graham Bolsover, Kingsville (CA); Jon-David Kehoe, Tilbury (CA); Lisa Whaley, Wheatley (CA)

Correspondence Address: LAURA M. SLENZAK, SIEMENS CORPORATION, 186 WOOD AVENUE SOUTH, ISELIN, NJ, 08830, US

(21) Appl. No.: 09/974,662

(22) Filed: Oct. 10, 2001

Related U.S. Application Data
(60) Provisional application No. 60/240,785, filed on Oct. 16, 2000.

(51) Int. Cl. F02M 1/00

(52) U.S. Cl. 123/456; 123/447

(57) ABSTRACT

A fuel rail assembly (10, 50) for an internal combustion engine of a motor vehicle includes a fuel rail (12) defining a main fuel chamber (14) and a plurality of fuel injectors (20) attached to mounting collars (22) disposed within the fuel rail (12). The main chamber of the fuel rail (12) includes an integrally formed damper section (30) defining a cross-section of the main fuel chamber (14) that directs fuel flow transversely relative to the main chamber (14) to attenuate pressure pulsation within the fuel rail (12). The damper section (30) includes opposing first and second members (34, 36) offset relative to each other to form a fluid passageway transverse to the main fuel chamber (14).

This invention claims priority to the provisional application serial No. 60/240,785, filed on Oct. 16, 2000.

### BACKGROUND OF THE INVENTION

This invention relates to a fuel rail assembly used in fuel injection systems for motor vehicles, and more specifically to a fuel rail assembly for controlling the pressure pulsation caused by the cyclical actuation of fuel injectors.

A fuel delivery system for a motor vehicle having a fuel injection system will typically include a fuel pump to deliver fuel to a fuel rail, which in turn distributes fuel to the fuel injectors. The fuel injectors are timed in such a manner that only specific fuel injectors are actuated at specific times. The actuation of the fuel injectors corresponds to the cycle of the engine. The cyclical actuation of the fuel injectors can cause pressure pulsations that travel through the fuel rail. Ideally, fuel pressure within the fuel rail is maintained at a specific optimal level for the injection of fuel into the cylinder of the engine. Fluctuations in the pressure within the fuel rail can disrupt the accurate metering of fuel by the fuel injectors. Inconsistent fuel pressure at the fuel injectors adversely effects performance in that the desired amount of metered fuel will vary with the amount of pressure within the fuel rail. Such conditions will affect the operation of the vehicle. Pressure pulsations within the fuel rail also cause undesirable noise.

Typically, a separate damper attached to the fuel rail by various fastening methods dampens pressure fluctuations within the fuel rail. The separate damper requires additional assembly steps that increase cost and complexity. It is desirable to simplify the assembly of a damper to the fuel rail. One method of easing assembly is to install a bellows damper within the fuel rail. The bellows damper responds to pressure pulsations within the fuel rail by expanding and contracting to dampen the magnitude of the pressure pulsation. The bellows damper is installed either at an end of the fuel rail or simply inserted within the fuel rail.

Another method of dampening pressure pulsations involves installation of dampening devices within a fuel rail to reflect a portion of pressure waves within a gaseous fuel back onto itself to reduce the magnitude of the pressure wave. However this fuel rail still requires the assembly of additional pieces to the fuel rail assembly at an increased cost.

For these reasons it is desirable to design a fuel rail assembly that dampens pressure fluctuations and eliminates the need for additional assembly and manufacturing steps.

### SUMMARY OF THE INVENTION

In a disclosed embodiment of this invention a fuel rail includes integrally formed dampening features to attenuate pressure fluctuations, reduce noise emission and eliminate the need for a separately installed dampening device.

The fuel rail assembly includes a fuel rail that defines a cylindrical main fuel chamber. A plurality of fuel injectors are attached to mounting collars disposed along the main fuel chamber. The main fuel chamber includes a damper section that defines a cross-section that directs the flow fuel in a direction transverse to the main fuel chamber. The dampening section includes integrally formed first and second members disposed opposite each other and offset a predetermined distance.

Another feature of this embodiment includes a circular cross section that attenuates pressure pulsations within the main fuel chamber by reflecting pressure waves back onto themselves. This is accomplished by providing the damper section with an inner diameter smaller than the inner diameter of the main chamber. The affect of the reduced cross section is to reflect a portion of any pressure wave back into oncoming pressure waves, thereby canceling the pressure pulsation produced with in the main chamber.

Another embodiment of the fuel rail assembly includes a damper chamber in fluid communication with the main chamber through a single inlet. A volume of fuel within the damper chamber expands and contracts to attenuate pressure pulsations within the main chamber.

The fuel rail assembly of the disclosed embodiments attenuates pressure fluctuations to provide a more consistent metering of fuel by including integrally formed dampening features to eliminate the additional assembly steps required for the installation of a separate dampening device.

### BRIEF DESCRIPTION OF THE DRAWINGS

The various features and advantages of this invention will become apparent to those skilled in the art from the following detailed description of the currently preferred embodiment. The drawings that accompany the detailed description can be briefly described as follows:

FIG. 1 is a cross-sectional view of one embodiment of the fuel rail assembly;

FIG. 2, is a cross-section through a first damper section;

FIG. 3, is a cross-sectional through a second damper section;

FIG. 4 is a top view of another embodiment of the fuel rail assembly; and

FIG. 5 is a cross sectional view of the fuel rail assembly of FIG. 4.

### DETAILED DESCRIPTION OF THE PREFERRED EMBODIMENT

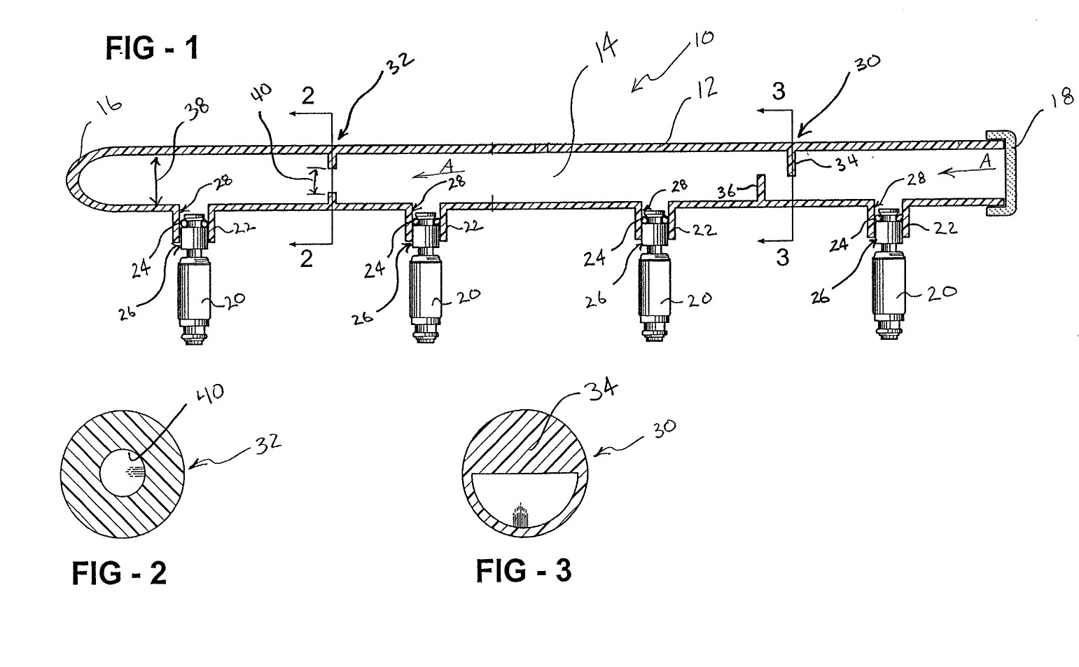

Referring to the Figures, wherein like numerals indicate like or corresponding parts throughout the several views, one embodiment of the fuel rail assembly is generally shown in FIG. 1 at 10. The assembly includes a fuel rail 12 defining a main fuel chamber 14. Preferably, the main chamber 14 is cylindrically shaped and includes first and second ends 16, 18.

Attached to the main chamber are a plurality of fuel injectors 20. Each of the fuel injectors 20 are mounted within a mounting collar 22 in fluid communication with the main chamber 14. The mounting collar 22 extends substantially perpendicular to the main chamber 14. A worker skilled in the art will recognize that it is within the scope of this invention that the mounting collars 22 may extend at other angles relative to the main chamber 14. Each fuel injector 20 includes a sealing member 24 that seals an outer diameter 26 of the fuel injector 20 against an inner diameter 28 of the mounting collar 22.

Referring to FIGS. 1 and 3, the main fuel chamber 14 includes a damper section 30. The damper section 30 defines a cross-section within the main fuel chamber 14 to direct fuel in a direction transverse to fuel entering the main fuel chamber 14 as indicated by arrow A. First and second members 34, 36 of the damper section 32 extend from the inner diameter 38 of the main chamber to accomplish the change in direction of fuel flow. The dramatic transverse direction change of fuel flow attenuates pressure pulsation within the fuel rail 12. Preferably, the first and second members 34, 36 are disposed opposite each other and offset a predetermined distance. The first and second members 34, 36 are preferably semicircular and block the flow of fuel through a portion of the main chamber 14. The first and second members 34, 36 are integrally formed within the main chamber 14 of the fuel rail 12 such that additional assembly is not required.

Referring to FIGS. 1 and 2, another configuration of a dampening section is indicated at 32 and includes a circular cross section 40 that attenuates pressure pulsations within the main fuel chamber 14 by reflecting pressure waves back onto themselves. This is accomplished by an inner diameter 40 of the damper section 32 being smaller than the inner diameter 38 of the main chamber 14. The affect of the reduced cross section is to reflect a portion of any pressure wave into further pressure waves, thereby canceling the pressure pulsation produced with in the main chamber 14. The damper section 32 is integrally formed within the fuel rail 12 such that no additional assembly steps are required. The number of dampening sections 30, 32 disposed within a fuel rail 12 depends on the specific configuration of the fuel rail 12. The length of the fuel rail 12 can require that at least two damper sections 30, 32 be formed within the main chamber 14. The pressure pulsation waves are created by the cyclical nature of fuel flow through the fuel injectors 20 during operation. For this reason it is desirable to locate a damper section 30, 32 between each of the fuel injectors 20 to dampen pressure pulsations caused by one fuel injector 20 from affecting the operation of the next fuel injector 20. One skilled in the art would understand that the position and number of damper section 30, 32 would vary depending on each specific application.

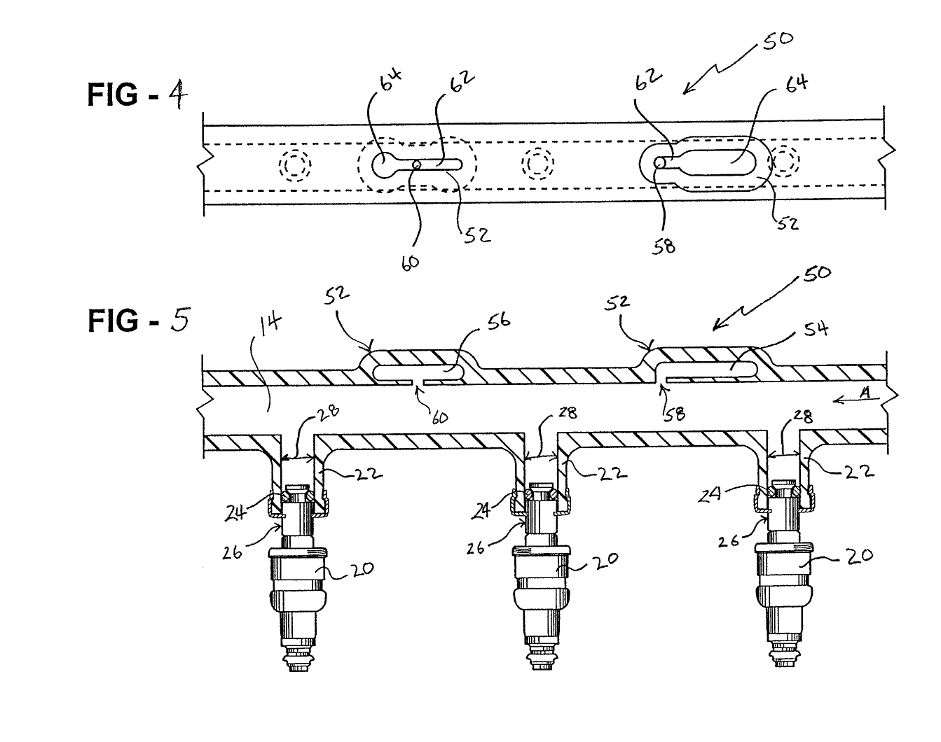

Referring to FIGS. 4 and 5, another embodiment of the fuel rail assembly 10 is shown generally at 50. In this embodiment, a damper section 52 is formed by chambers 54 and 56 that are in fluid communication with the main chamber 14 through openings 58, 60. A volume of fuel within the damper chambers 54, 56 expands and contracts to attenuate pressure pulsations within the main chamber 14.

The chambers 54, 56 include an inlet section 62 and a damper section 64. The openings 58, 60 are in fluid communication with the inlet sections 62. The damper section 64 of the chambers 54, 56 is substantially larger in cross-section that that of the inlet sections 62. The specific shape of the inlet section 62 and the damper section 64 may be of any shape. In the embodiment shown in FIG. 5, a circular and an oval shaped damper section are shown. The size and cross-sectional shape of the damper chambers 54, 56 are dependent on specific application requirements such as shape and the magnitude of pressure pulsations to be attenuated. Many different configurations of the damper chambers 54, 56 are within the scope of this invention and a worker skilled in the art would understand that different shapes fall within the scope of this invention.

Each of the damper chambers 52 are integrally formed within the fuel rail 50 thereby eliminating assembly steps in the manufacturing process. Again as discussed hereinabove, the number of damper chambers 52 is dependent on the specific application and the configuration of the specific fuel rail 12. The fuel rail 50 shown in FIGS. 4 and 5 includes a damper chamber 52 between each of the fuel injectors 20. Locating a dampening chamber 52 between each of the fuel injectors 20 to effectively isolate each of the fuel injectors 20 from pressure pulsations caused by the actuation of the other fuel injectors 20.

The foregoing description is exemplary and not just a material specification. The invention has been described in an illustrative manner, and should be understood that the terminology used is intended to be in the nature of words of description rather than of limitation. Many modifications and variations of the present invention are possible in light of the above teachings. The preferred embodiments of this invention have been disclosed, however, one of ordinary skill in the art would recognize that certain modifications are within the scope of this invention. It is understood that within the scope of the appended claims, the invention may be practiced otherwise than as specifically described. For that reason the following claims should be studied to determine the true scope and content of this invention.

What is claimed is:

1. A fuel rail assembly for an internal combustion engine of a motor vehicle, said fuel rail assembly comprising:
a fuel rail defining a main fuel chamber,
a plurality of fuel injectors attached to said fuel rail and in fluid communication with said main fuel chamber; and
said main fuel chamber having at least one damper section defining a cross-section of said main fuel chamber that directs fuel flow transversely relative to said main chamber to attenuate pressure pulsation within said fuel rail.

2. The assembly of claim 1, wherein said main chamber includes a substantially circular cross-section defining an inner diameter.

3. The assembly of claim 2, wherein said damper section includes opposing first and second members offset a predetermined distance from each other to form a fuel passageway transverse to said main chamber.

4. The assembly of claim 3, wherein said first and second members include a semi-circular cross-section generally blocking fuel flow through half of said main chamber.

5. The assembly of claim 3, wherein said predetermined distance is sized such that fuel flow is directed transverse to said main chamber without restricting fuel flow to said fuel injectors.

6. The assembly of claim 2, wherein said damper section includes an inner diameter to partially block fuel flow through said main chamber, said damper section inner diameter smaller than said inner diameter of said main chamber.

7. The assembly of claim 1, wherein said damper section is integrally formed into said fuel rail.

8. The assembly of claim 1, wherein one of said damper sections are disposed between two of said plurality of fuel injectors.

9. A fuel rail assembly for an internal combustion engine of a motor vehicle, said fuel rail assembly comprising:
a fuel rail defining a main fuel chamber,
a plurality of fuel injectors attached to said fuel rail and in fluid communication with said main fuel chamber; and
a damper chamber in fluid communication with said main chamber and including a single opening such that a volume of fuel within said dampening chamber expands and contracts to attenuate pressure pulsations within said main chamber.

10. The assembly of claim 9, wherein said dampening chamber includes an inlet section and a damper section, said opening disposed within said inlet section and said damper section having a greater cross-sectional area relative to said damper section.

11. The assembly of claim 9, wherein said damper section is generally oval shaped.

12. The assembly of claim 9, wherein said damper section is generally circular shaped.

13. The assembly of claim 9, wherein said damper chamber is integrally formed within said fuel rail.

14. The assembly of claim 9, wherein there are at least two damper chambers disposed within said main chamber of said fuel rail.
